(19) United States
(12) Patent Application Publication
(10) Pub. No.: US 2003/0144954 A1
(43) Pub. Date: Jul. 31, 2003

(54) Walk-up communication station

(75) Inventors: Edgar Quarles, Dallas, TX (US); Dong-Gyun Kim, Seoul (KR)

Correspondence Address: ROBERT GROOVER III, 1717 MAIN STREET, SUITE 4100, DALLAS, TX, 75201-4605, US

(73) Assignee: FL Technology Inc.

(21) Appl. No.: 10/293,973

(22) Filed: Nov. 12, 2002

Related U.S. Application Data
(63) Continuation-in-part of application No. 10/099,047, filed on Mar. 15, 2002.

(30) Foreign Application Priority Data
Mar. 15, 2001 (KR) 2001-13449

(51) Int. Cl. G06F 17/60

(52) U.S. Cl. 705/40

(57) ABSTRACT

A walk-up communication station which not only provides conventional pay phone functions (with conventional handset and keypad), but also provides a touchscreen interface for Web browsing, and a variety of dataport connections for attaching a laptop. For security, the dataport and the station's CPU are both separately firewalled from the internet connection, and are not otherwise networked together.

### CROSS-REFERENCE TO OTHER APPLICATION

This application claims priority as a CIP of Ser. No. 10/099,047 filed Mar. 15, 2002, entitled “On-Line Cash Withdrawal and Financial Service Apparatus and Method of Providing the Service Using Integrated Internet and Telephony Service Terminal,” and therethrough claims priority from Korean application 2001-13449, filed Mar. 15, 2001, both of which are hereby incorporated by reference.

The parent application described a public communication station which provides a large variety of functions to e.g. walk-up customers. The present application describes implementation choices, improvements, and inventions which have occurred during further refinement of that system.

### BACKGROUND AND SUMMARY OF THE INVENTION

The present invention relates to public communication terminals.

Background Walk-Up Public Telecommunication

Pay telephones have long been a basic tool for providing some communication capability to people in public places. Even with the increasing use of cell phones, pay telephones are still a very useful part of the communication system.

However, the service provided by a pay phone has been essentially the same for most of a century, i.e. a voice connection and nothing more. By contrast, other telecommunications interfaces have become much more capable, not merely in raw bandwidth but in functionality.

Walk-Up Communication Station

The present application and the parent application both disclose many new ways to provide more communication functionality in a walk-up communication station, while retaining backward compatibility with the most familiar features of a pay phone. MANY innovations are described herein, and can be used separately or in various combinations.

In one class of innovative teachings, the present application discloses a walk-up communication station which has numerous available communication modes, including some or all of the following:

voice-over-IP service;

ordinary voice call service;

hands-free calling service;

special telephony interface modes for the hearing-impaired (speech recognition);

Web browsing without a computer;

Web content filtering;

videophone/videoconferencing service;

security camera functionality (automatically or remotely directed image capture);

face recognition;

video email;

display of advertisements;

call-dependent advertisement display (where the number called can be compared against a minimal stored directory, and used to select end-user-appropriate advertising);

bank/credit/debit card input;

encrypted transmission of bank charge information;

passworded access to prepaid accounts;

music downloads (e.g. of MP3 files);

content filtering (for Web pages called up on the display screen);

compact messaging protocol functions (e.g. SMS);

dispensing tickets or other certificates of value;

dataport service;

wireless (e.g. WiFi or 802.11b) dataport service;

special internet interface modes for the visually impaired (pointer-to-audio, text to speech, speech recognition, and/or zoom);

automated teller machine (ATM) functions; and

wireless data connection service (e.g. IRDA downloads into portable devices).

As detailed below, many subcombinations of this set are believed to be novel and advantageous, and are sought to be protected.

Another area of innovative teachings relates to the many I/O channels which support these communications modes. In various disclosed embodiments, these include some or all of the following:

bank card reader (with interface to chip cards, magnetic stripe cards, and/or RF cards);

confirmation slip printer;

wireless data interface (e.g. IRDA and/or WiFi);

video camera;

display;

microphone;

telephone handset;

speaker(s);

coin/bill acceptance functions;

touch screen;

cash dispensing module;

keyboard; and

keypad.

As detailed below, many subcombinations of this set are believed to be novel and advantageous, and are sought to be protected.

Yet another area of innovative teachings relates to the architectural features which provide security. (Security is one of the basic demands in any Internet appliance, especially in one which handles financial transactions.) Security is particularly difficult where so many high-bandwidth functions are supported, and where so many I/O channels are present. In various disclosed embodiments, these include some or all of the following:

Two disjunct network segments are used: the connection from the dataport to the internet is entirely separate from the control processor's connection to the internet.

Two separate firewalls are used: one protects the dataport's IP address(es) from open internet access, and one separates the control processor's address(es) from open internet access.

The dataport is separated from the internet by an extra firewalling step: IP addresses are remapped even if the connecting laptop is already declaring its IP address. (This is different from standard DHCP.)

The keyboard is intentionally made slightly nonstandard, so that the different key codes will make provide a little extra difficulty for hackers.

As detailed below, many subcombinations of this set are believed to be novel and advantageous, and are also sought to be protected.

Yet another innovative teaching, which can be used separately from or together with the above functions, is a computer-controlled cover over the dataport connections. This provides additional protection against vandalism.

One of the advantages of some embodiments is that the analog components which are connected to the POTS line can provide minimal telephone service even if the system power fails or the processor fails completely. (Conventional POTS-line interface standards require the line to supply power to the interface components.) A further advantage of providing a POTS line connection is that the uncertainty of finding an appropriate routing for a desired voice-over-IP call is minimized, since the POTS connection is available for a fallback.

### BRIEF DESCRIPTION OF THE DRAWING

The disclosed inventions will be described with reference to the accompanying drawings, which show important sample embodiments of the invention and which are incorporated in the specification hereof by reference, wherein:

FIG. 1 is a diagram of a first sample embodiment, showing the structure of an on-line cash withdrawal and financial service apparatus utilizing an integrated internet and telephony service terminal;

FIG. 2 shows the configuration of a network of the on-line cash withdrawal and financial service apparatus of FIG. 1 connected to multiple integrated service terminals; and,

FIG. 3 is a flowchart illustrating a method of providing an on-line cash withdrawal and financial service using an integrated service terminal according to e.g. FIG. 1;

FIG. 4 shows the physical configuration of another sample embodiment, which does not include cash dispensing functions;

FIG. 5 shows how process components, in a system embodiment such as that of FIG. 4, cooperate to provide telephone functionality;

FIG. 6 shows how process components, in a system embodiment such as that of FIG. 4, cooperate to provide dataport functionality;

FIG. 7 is a block diagram of the embodiment of FIG. 4, conceptually showing how network segmentation and two firewalls are preferably used to give safe internet connectivity to the dataport and to the station's controller.

Many more Figures are included in the attached Appendix.

### DETAILED DESCRIPTION OF THE PREFERRED EMBODIMENTS

The numerous innovative teachings of the present application will be described with particular reference to the presently preferred embodiment (by way of example, and not of limitation).

Teachings of the Parent Application

The parent application describes an on-line cash withdrawal and financial service apparatus and a method of providing the service using an integrated internet and telephony service terminal, and more particularly, to an on-line cash withdrawal and financial service apparatus and a method of providing the service, in which a multimedia service terminal integrated with an internet browsing terminal, a public telephone, and a cash dispense is used so that a user can be conveniently provided with a variety of services at one public place.

In general, dedicated terminals for browsing the Internet, making telephone calls and accessing financial services are separately installed at different locations. Therefore, an individual must move from place to place when he/she needs to access two or more services one after the other, which is inconvenient and wastes time and money. However, integrating such terminals for separate services into a single terminal is not easy because it involves a need of distributing the profit to many service providers. Therefore, there is a need for a new integrated service apparatus and a method of providing the integrated service, which are favorable to both users and service providers.

The parent describes an on-line cash withdrawal and financial service apparatus and a method of providing the service using a multimedia service terminal integrated with an Internet browsing terminal, a public telephone, and a cash dispenser, which are convenient for the user since multiple services can be provided at one location, thus saving time and money.

According to one disclosed aspect, there is provided an on-line cash withdrawal and financial service apparatus using an integrated internet and telephony service terminal comprising: a liquid crystal display which displays service data; a touch screen which allows a user to input data by touching; a keyboard which allows the user to input data; a card reader which allows the user to pay by credit card; a video camera which allows the user to communicate with the opposite party using picture data; a dial keypad which allows the user to dial a number that he/she wants to call; a printer capable of printing the data processed by each constituent unit; a cash dispenser which dispenses a predetermined amount of money the user who has passed his/her credit card through the card reader wishes to withdraw; and a controller which processes the data provided from each constituent unit.

It is preferable that the on-line cash withdrawal and financial service apparatus further comprises: an asymmetric digital subscriber line (ADSL) modem which transfers the data processed by the controller to a public ADSL; and a speech board which enables the user to make a telephone call.

It is preferable that the liquid crystal display is a thin-film transistor liquid crystal display. It is preferable that the touch screen is a kind of optical touch screen. It is preferable that the card reader is compatible for both integrated circuit (IC) card and magnetic card. It is preferable that the printer is a thermal transfer type printer. It is preferable that the controller comprises a built-in local area network (LAN).

According to another disclosed aspect, there is provided an on-line cash withdrawal and financial service apparatus comprising: at least one integrated service terminal capable of providing internet and telephony services and including a liquid crystal display, a touch screen, a keyboard, a card reader, a video camera, a dial keypad, a printer, a cash dispenser, a controller, an asymmetric digital subscriber line modem, a speech board and a handset; a billing and management server which provides and manages a variety of services from the at least one integrated service terminal through the Internet for a user; a switch network which transmits a variety of services provided from the at least one integrated service terminal through the Internet to the user who is a wire-based or wireless subscriber; and a financial network which receives financial transaction request data input from the at least one integrated service terminal through the Internet and transmits the received financial transaction request data to a bank server or a card issuer server to provide the user with a requested financial service.

It is preferable that the at least one integrated service terminal provides the user through the Internet with web-to-call, web browsing, e-mail, contents retrieval, VoIP (Voice-over-Internet Protocol), mobile communications, electronic commerce, reservation, ticket purchasing, a variety of types of applications, financial transactions, chatting, electronic POX (post office box), and free advertising call services.

It is preferable that the at least one integrated service terminal provides banking transaction services including cash dispensing, account-to-account fund transfer, account balance inquiry, and payment of bills, in conjunction with the bank server or the card issuer server.

It is preferable that the at least one integrated service terminal provides telephone call services paid for by cash, membership card, credit card, prepaid cash card, telephone card, or the person receiving the call, or in conjunction with home phone number or mobile phone number.

According to another aspect of the present invention, there is provided a method of providing an on-line cash withdrawal and financial service using an integrated service terminal, the method comprising: they integrated service terminal being ready to comply with a user's service request; determining whether a user has requested an on-line service for a predetermined period of time; if there is an on-line service request by the user, providing a telephone call service, an Internet service, or a financial service according the user's on-line service request; after the financial service is provided, determining whether to dispense cash to the user based on the result of the financial service; and if it is determined to dispense cash to the user, dispensing a predetermined amount of money requested by the user and printing a receipt out for the user.

It is preferable that the telephone call service includes private branch exchange (PBX) and VoIP services, telephony and video communications services through data processing, and billing for the service. It is preferable that the Internet service includes web browsing, e-mail, contents retrieval, and e-commerce services, and billing for the service. It is preferable that the financial service includes a user authentication and transaction approval services for each transaction and each bank.

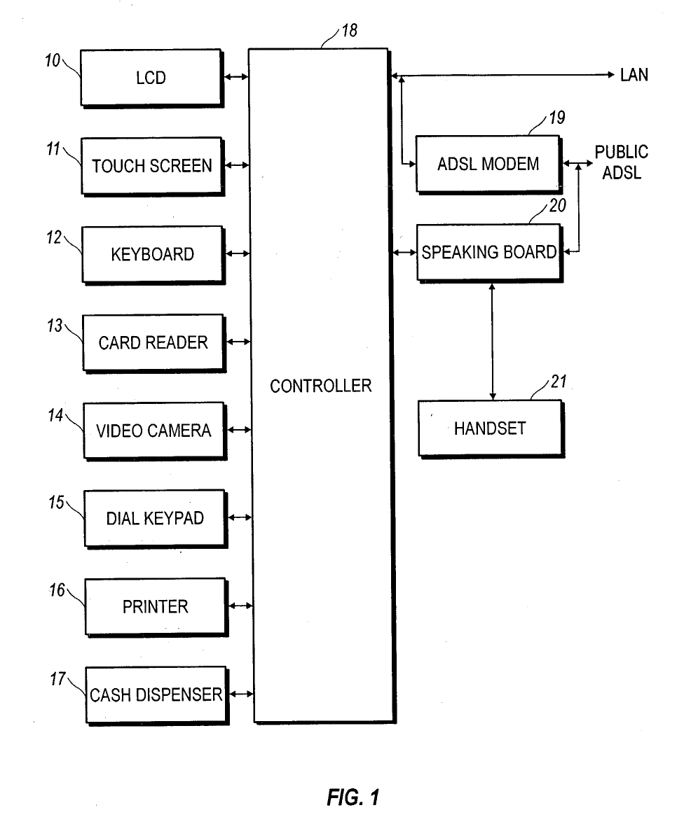

The configuration of an on-line cash withdrawal and financial service apparatus using an integrated internet and telephony service terminal according to the present invention is shown in FIG. 1. Referring to FIG. 1, the on-line cash withdrawal and financial service apparatus according to the present invention includes a liquid crystal display (LCD), a touch screen 11, a keyboard 12, a card reader 13, an video camera 14, a dial keypad 15, a printer 16, a cash dispenser 17, a controller 13, an asymmetric digital subscriber line (ADSL) modem 19, a speech board 20, and a handset 21.

The TFT-type LCD 10 displays a variety of transaction data. The touch screen 11, a kind of optical touch screen device, allows a user to input data by touching the screen. Also, the keyboard 12 allows the user to input data. The card reader 13, which is compatible for both IC and magnetic cards, allows the user to pay by credit card. The video camera 14 enables the user to communicate with the opposite party using picture data. The dial keypad 15 allows the user to dial a number that he/she wants to call.

The printer 16 is a thermal transfer type printer capable of printing data processed by each constituent unit. The cash dispenser 17 dispenses a predetermined amount of money the user who has passed his/her credit card through the card reader 13 wishes to withdraw. The controller 18, in which a LAN is embedded, processes data provided from each constituent unit. The ADSL modem 19 transfers a variety of data processed by the controller 18 through a public ADSL. The speech board 20 enables the user to make a telephone call using the handset 21.

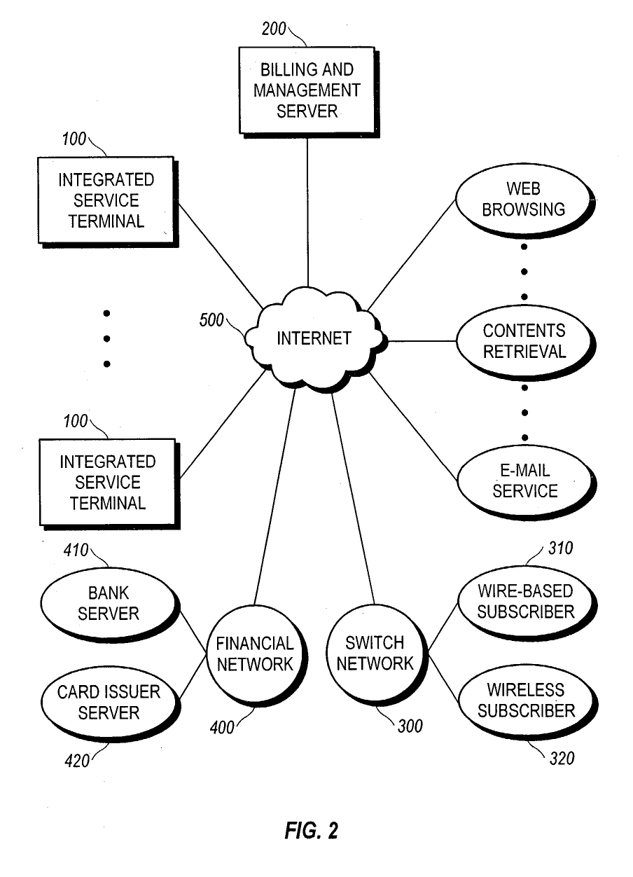

FIG. 2 shows the configuration of a network of the on-line cash withdrawal and financial service apparatus of FIG. 1 connected to multiple integrated service terminals. As shown in FIG. 2, at least one integrated service terminal 100, a billing and management server, a switch network 300, a financial network 400, the Internet 500 comprise the network of the on-line cash withdrawal and financial service apparatus according to the present invention.

Each integrated service terminal 100 comprises the LCD 10, the touch screen 11, the keyboard 12, the card reader 13, the video camera 14, the dial keypad 15, the printer 16, the cash dispenser 17, the controller 18, the ADSL modem 19, the speech board 20, and the handset 21, which are shown in FIG. 1. The integrated service terminal 100 provides the user through the Internet 500 with a variety of services such as web-to-call, web browsing, e-mail, contents retrieval, VoIP (Voice-over-Internet Protocol), mobile communications, electronic commerce, reservation, ticket purchasing, a variety of types of applications, financial transactions, chatting, e-POB (post office box), and free advertising call services.

The billing and management server 200 provides and manages a variety of services from the integrated service terminal 100 through the internet 500 for the user. The integrated service terminal 100 provides, in conjunction with a bank server 410 or a card issuer server 420, banking transaction services, such as cash dispensing, account-to-account fund transfer, account balance inquiry, and payment of bills, and telephone call services paid for by cash, membership card, credit card, prepaid cash card, telephone card, or the person receiving the call, or in conjunction with home telephone number or mobile phone number.

The switch network 300 provides a variety of services provided from the integrated service terminal 100 through the Internet 500 to a wire-based subscriber 310 and a wireless subscriber 320. The financial network 400 receives financial transaction request data input from the integrated service terminal 100 through the Internet 500 and transmits the received financial transaction request data to the bank server 410 or the card issuer server 420 to provide the user with a requested financial service.

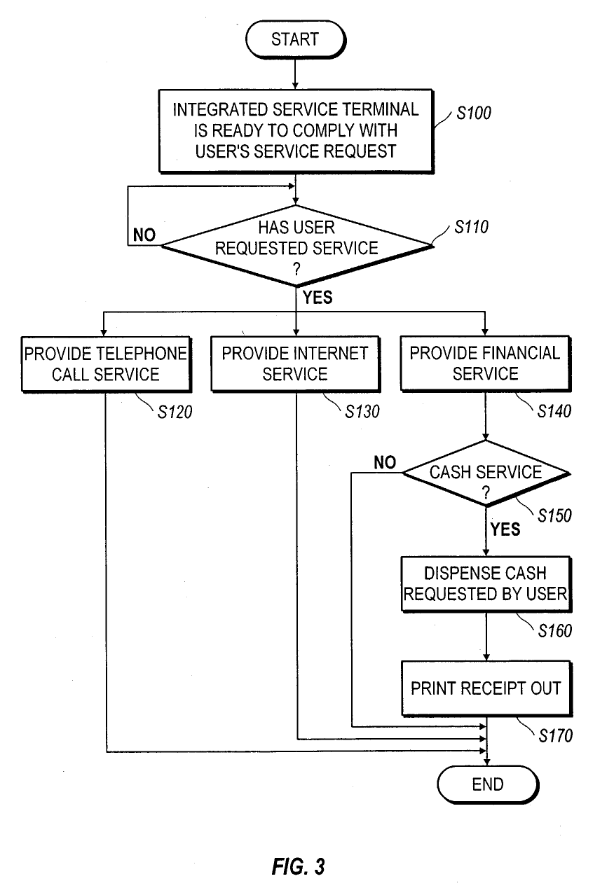

FIG. 3 is a flowchart illustrating a method of providing an on-line cash withdrawal and financial service using an integrated service terminal according to the present invention.

Referring to FIG. 3, the integrated service terminal 100 of FIG. 2 is ready to comply with a user's service request (step S100). It is determined whether the user has requested an on-line service for a predetermined period of time (step S110). If there is an on-line service request by the user, according to the user's on-line service request, a telephone call service (step S120), an Internet service (step S130), or a financial service (step S140) is provided. The telephone call service in step S120 includes private branch exchange (PBX) and VoIP services, telephony and picture communications services through data processing, and billing for the service. The Internet service in step S130 includes a web browsing, e-mail, contents retrieval, e-commerce, and billing for the service. The financial service in step S140 includes a user authentication and transaction approval service for each transaction and each bank.

After step S140 is complete, it is determined whether to provide cash to the user according to the user's request based on the result of step S140. If it is determined in step S150 to provide cash to the user, the integrated service terminal 100 dispenses an amount of money requested by the user (step S160) and prints a receipt (step S170) out for the user.

In the on-line cash withdrawal and financial service apparatus and the method of providing the service using an integrated multimedia terminal according to the present invention, it is convenient for a user, in terms of time and money, to utilize the integrated multimedia terminal for multiple transactions. Also, the service provider can reduce installation and maintenance expenses because multiple services can be provided at one location using a single integrated multimedia terminal. The service provider operating the integrated multimedia terminal is expected to yield a high profit. The provision of integrated information useful for everyday living to a number of users leads to an advanced information-based society.

Embodiments Without Cash Dispensing

Further development has shown that the disclosed innovations provide great advantages even without the currency dispensing capabilities.

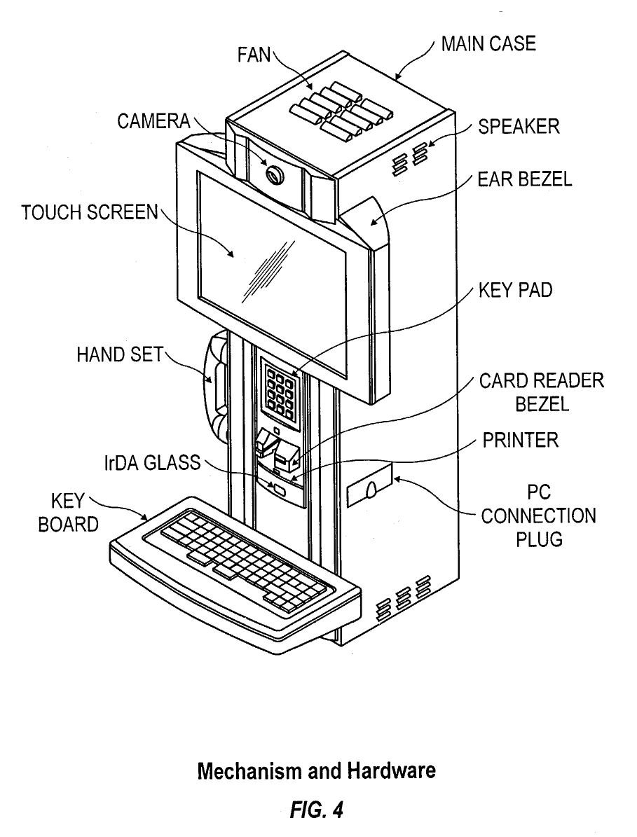

FIG. 4 shows a sample embodiment without cash dispensing functions. As shown in this Figure, this embodiment includes camera, display, IR port, dataport connectors, keyboard, handset, dial pad, speaker, microphone, slip printer, and card reader functions. However, as discussed above and below, more or fewer functions can alternatively be included.

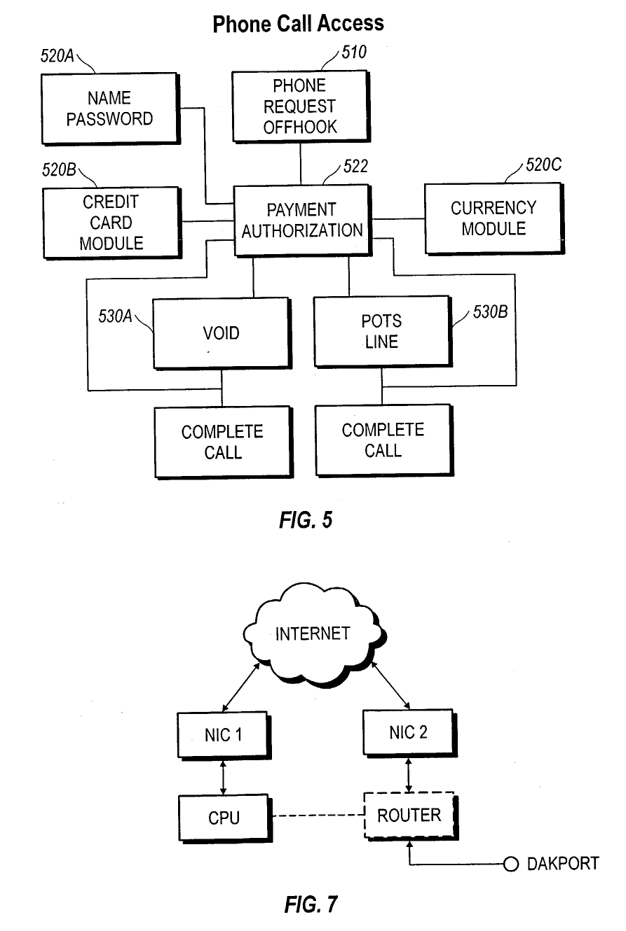

FIG. 5 shows how process components, in a system embodiment such as that of FIG. 4, cooperate to provide telephone functionality. When a request for telephone activity is initiated (by a user taking the handset offhook, step 510), the next step is payment. This can be accomplished e.g. by receiving satisfactory inputs from the card reader module (step 520B), with appropriate authentication by the remote station; or by receiving satisfactory inputs from a currency module (step 520C); or by receiving a name/password combination which matches into a database of prepaying users (step 520A).

Once payment authorization has been received (step 522), the call can be placed. The preferred embodiment allows the call to be placed either using (step 530B) a “plain old telephone service” (“POTS”) line, i.e. an analog line filtered to 2700 Hz of bandwidth, or using voice-over-IP (“VoIP”) functionality (step 530A).

The operator of the station can decide how the choice between VoIP and POTS is to be made. Depending on the location, VoIP is usually a more profitable service, but POTS is likely to be more reliable. A further factor is that in some locations VoIP may offer better signal quality.

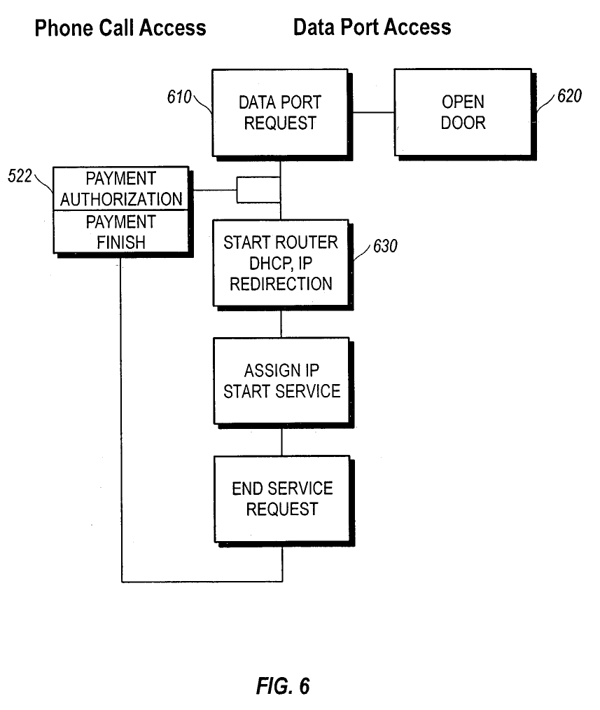

FIG. 6 shows how process components, in a system embodiment such as that of FIG. 4, cooperate to provide dataport functionality. Once a request for dataport access is received (step 610), e.g. by a user activating an appropriate command on the touch screen, a solenoid-operated lock allows a door over the physical dataport connectors to be unlocked (step 620). This can either be done while payment is being authenticated (as shown), or alternatively the door can be kept locked until the payment process is complete.

A router process is then launched (step 620). Preferably the router process turns on DHCP (listening for IP requests), and then (if none are found) looks for broadcast IPs. Preferably the broadcast IPs are remapped too; note that this is not standard DHCP operation, but is an added security feature. Router operation then continues conventionally with IP remapping transparent to the user's computer, and runs until the session is over.

Some virtual private networks will not accept access except from a known IP, and users attempting VPN access to such VPNs will be thwarted by this security feature. However, for most VPNs the simple tunnelling protocol provided here will still permit users to obtain their usual remote access.

In this sample embodiment the router process is simply a software service running on the CPU. The router process remaps all IP addresses between the dataport and the internet.

FIG. 7 is a block diagram of the embodiment of FIG. 4, conceptually showing how two NICs and two firewalls are preferably used to give safe internet connectivity to the dataport and to the station's controller. The two separate NICs (network interface components) provide isolation between the CPU and the dataport; this is an additional security feature. Since the router is implemented, in this sample embodiment, as a software service of the CPU rather than a separate component, the CPU does actually have physical connection to both NICs; but the data communication paths are, as shown, separate.

Note that an uninterruptible power supply (UPS) provides extra operating stability for the processor unit. The processor itself, in this sample embodiment, is a ruggedized (mil-spec) Pentium III module supported by a 40 GB hard drive (but of course these specifications will change over time). A separate module provides secure DES3 encryption functions. Another board provides speech functions, and another provides telephone line interface functions. Further subboards are mounted with other components, e.g. printer, camera etc.

A further robustness feature is an EPROM into which codes are written even if the UPS fails.

Many more Figures are included in the attached Appendix, which provides exhaustive detail regarding a sample implementation.

Preferably content filtering is applied to display access (to avoid scandalizing passersby), but not to the dataport.

The dataport preferably provides USB and Ethernet connections, in addition to the connectivity provided by the infrared (IRDA) wireless port. (IR is a slower interface but of course does not require a physical hook-up.)

Embodiments Without Telephone Service

A still further class of embodiments omits the telephone service. Pay phone service is tightly regulated in many countries; for example, each of the 50 states in the U.S. has its own regulations on pay phones. The combination of web-access and money-handling functions provides a considerable synergy for users, even without the telephone service. The combination of cash-receiving and cash-dispensing hardware with secure (DES3) communications makes this combination particularly advantageous for walk-up implementation of e-commerce.

According to a disclosed class of innovative embodiments, there is provided: A communications station, comprising: voice telephony functions; videophone functions; and payment collection functions.

According to another disclosed class of innovative embodiments, there is provided: A communications station, comprising: audio detection and output components; a processor unit which provides voice-over-internet functionality using at least said audio detection and output components; and a dataport, accessible by a user's computer, which provides internet connectivity; wherein said dataport is not networked directly to said processor, and is prevented from seeing IP addresses of said processor.

According to another disclosed class of innovative embodiments, there is provided: A communications station, comprising: audio detection and output components; a processor unit which provides voice-over-internet functionality using at least said audio detection and output components; and a dataport, accessible by a user's computer, which provides internet connectivity; wherein all network communication between said dataport and said processor is mediated by at least two firewalling operations.

According to another disclosed class of innovative embodiments, there is provided: A communications station, comprising: a dataport, accessible by a user's computer, which provides internet connectivity; a processor unit which provides internet access to paying users, without requiring access to said dataport; wherein all network communication between said dataport and said processor is mediated by at least two firewalling operations.

According to another disclosed class of innovative embodiments, there is provided: A communications station, comprising: a dataport, accessible by a user's computer, which provides internet connectivity; a processor unit which provides a remote payment capability for receiving and verifying credit card or other payment information; wherein all network communication between said dataport and said processor is mediated by at least two firewalling operations.

According to another disclosed class of innovative embodiments, there is provided: A communications station, comprising: a dataport, accessible by a user's computer, which provides internet connectivity; firewalling components which remap network addresses declared by the user's computer, even if the user's computer is already declaring a valid network address which does not have to be remapped; and a processor which has its own autonomous internet access, independently of said dataport, and which is not directly networked thereto.

According to another disclosed class of innovative embodiments, there is provided: A communications station, comprising: a telephone interface which allows a paying user to make telephone calls; and a dataport which provides internet connectivity to another paying user's computer; wherein access to said dataport is not locked out, even when another single user is completely occupying said telephone interface; and wherein access through said dataport is billed independently of access through said telephone interface, and is not constrained by what number is accessed through said telephone interface.

According to another disclosed class of innovative embodiments, there is provided: A communications station, comprising: a dataport, with one or more connectors accessible by a user's computer, which provides internet connectivity; a wireless interface, which also provides internet connectivity to a user's computer without use of said dataport; and a telephone interface which is usable by users who do not have a computer.

According to another disclosed class of innovative embodiments, there is provided: A communications station, comprising: a POTS telephone line connection; a data connection to the internet; a processor unit which controls user access to the internet through said internet connection; and a dial pad, and microphone and speaker components, connected through analog components to said POTS; said analog components being connected to receive power from said POTS connection, even when no other power is present, to supply minimum telephone service even when said processor unit is not functioning.

According to another disclosed class of innovative embodiments, there is provided: A method for providing public communications capability, comprising the action of: providing a communication station as above for public use.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

Note that the “touch” screen does not strictly have to involve a finger touching the front surface of the display; in alternative embodiments the detection beam paths can be arranged e.g. to detect the position of a fingertip (or pen tip) which is poised above the plane of the display.

In alternative system embodiments other pointing devices can be provided for user input, e.g. a trackball or a joystick, instead of or in addition to the touch screen described above.

Alternatively, the described apparatus can be used for dispensing other thin sheets of high-value material, e.g. lottery tickets, train/air/ship tickets, tax stamps, electronically authenticated certificates of exchange, or other valuta. However, use for currency dispensing, which has unique requirements, is by far the most preferred embodiment.

The internet connection does not have to be a DSL line, but can alternatively be ISDN, T1, fractional T1, 100baseT, or many other formats. The internet connection may be connected through a LAN to a router.

The printer does not strictly have to be a thermal printer, but can alternatively be inkjet, impact, other, or omitted.

The display can alternatively be a CRT, a plasma screen, or other technology.

The router functionality can optionally be implemented in hardware, e.g. by using a “smart NIC” to provide this functionality.

In a contemplated future embodiment, high-bandwidth wireless access (e.g. “WiFi”) can be combined with the functions described above. This has the particular advantage that one small fixed physical location can provide a larger flow of connectivity, and hence a larger cash flow. In this embodiment the users would preferably be allowed to enter billing information from their laptops, without having to physically touch the display at all. However, the physical and data security provided by the station described is still an important component of making this connectivity practicable. Many references have been made to payment, but in some countries telephone service is normally free. Many of the disclosed inventions are readily applicable to free service, or to a hybrid service which mixes pay features and free features.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. Moreover, the claims filed with this application are intended to be as comprehensive as possible: EVERY novel and nonobvious disclosed invention is intended to be covered, and NO subject matter is being intentionally abandoned, disclaimed, or dedicated.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A communications station, comprising:
voice telephony functions;
videophone functions; and
payment collection functions.

2. The communications station of claim 1, wherein the station also provides special communication functions for hearing-impaired persons.

3. The communications station of claim 1, wherein the station also provides special communication functions for visually impaired persons.

4. A method for providing public communications capability, comprising the action of: providing a communication station according to claim 1, for public use.

5. A communications station, comprising:
audio detection and output components;
a processor unit which provides voice-over-internet functionality using at least said audio detection and output components; and
a dataport, accessible by a user's computer, which provides internet connectivity;
wherein said dataport is not networked directly to said processor, and is prevented from seeing IP addresses of said processor.

6. The communications station of claim 5, wherein the station also provides special communication functions both for hearing-impaired persons and also for visually impaired persons.

7. The communications station of claim 5, wherein said processor also manages payment authorizations.

8. A method for providing public communications capability, comprising the action of: providing a communication station according to claim 5, for public use.

9. A communications station, comprising:
audio detection and output components;
a processor unit which provides voice-over-internet functionality using at least said audio detection and output components; and
a dataport, accessible by a user's computer, which provides internet connectivity;
wherein all network communication between said dataport and said processor is mediated by at least two firewalling operations.

10. A method for providing public communications capability, comprising the action of: providing a communication station according to claim 9, for public use.

11. A communications station, comprising:
a dataport, accessible by a user's computer, which provides internet connectivity;
a processor unit which provides internet access to paying users, without requiring access to said dataport;
wherein all network communication between said dataport and said processor is mediated by at least two firewalling operations.

12. The communications station of claim 11, wherein said firewalling operations are each performed in software.

13. A method for providing public communications capability, comprising the action of: providing a communication station according to claim 11 for public use.

14. A communications station, comprising:
a dataport, accessible by a user's computer, which provides internet connectivity;
a processor unit which provides a remote payment capability for receiving and verifying credit card or other payment information;
wherein all network communication between said dataport and said processor is mediated by at least two firewalling operations.

15. The communications station of claim 14, wherein said firewalling functions are implemented as software on said processor unit.

16. The communications station of claim 14, wherein said processor also keeps a local database of accounts, to provide prepaid services to password-authorized users.

17. A method for providing public communications capability, comprising the action of: providing a communication station according to claim 14 for public use.

18. A communications station, comprising:
a dataport, accessible by a user's computer, which provides internet connectivity;
firewalling components which remap network addresses declared by the user's computer, even if the user's computer is already declaring a valid network address which does not have to be remapped; and
a processor which has its own autonomous internet access, independently of said dataport, and which is not directly networked thereto.

19. A method for providing public communications capability, comprising the action of: providing a communication station according to claim 14 for public use.

20. A communications station, comprising:
a telephone interface which allows a paying user to make telephone calls; and
a dataport which provides internet connectivity to another paying user's computer;
wherein access to said dataport is not locked out, even when another single user is completely occupying said telephone interface;
and wherein access through said dataport is billed independently of access through said telephone interface, and is not constrained by what number is accessed through said telephone interface.

21. A method for providing public communications capability, comprising the action of: providing a communication station according to claim 20 for public use.

22. A communications station, comprising:
a dataport, with one or more connectors accessible by a user's computer, which provides internet connectivity;
a wireless interface, which also provides internet connectivity to a user's computer without use of said dataport; and
a telephone interface which is usable by users who do not have a computer.

23. The communications station of claim 22, further comprising a videophone interface which is also usable by users who do not have a computer.

24. A method for providing public communications capability, comprising the action of: providing a communication station according to claim 22 for public use.

25. A communications station, comprising:
a POTS telephone line connection;
a data connection to the internet;
a processor unit which controls user access to the internet through said internet connection; and
a dial pad, and microphone and speaker components, connected through analog components to said POTS; said analog components being connected to receive power from said POTS connection, even when no other power is present, to supply minimum telephone service even when said processor unit is not functioning.

26. The communications station of claim 25, wherein the station also provides special communication functions both for hearing-impaired persons and also for visually impaired persons.

27. The communications station of claim 25, wherein said microphone and speaker components are contained in a single telephone handset.

28. A method for providing public communications capability, comprising the action of: providing a communication station according to claim 25 for public use.
